(19) United States
(12) Patent Application Publication
(10) Pub. No.: US 2011/0260533 A1
(43) Pub. Date: Oct. 27, 2011

(54) Sustainable Modular Structure Powered by Green Energy

(76) Inventor: Bradley Spencer Hardin, Solana Beach, CA (US)

(21) Appl. No.: 13/050,867

(22) Filed: Mar. 17, 2011

Related U.S. Application Data
(60) Provisional application No. 61/314,716, filed on Mar. 17, 2010.

(51) Int. Cl. H02J 7/34; H02J 1/10

(52) U.S. Cl. 307/21; 307/80

(57) ABSTRACT

A sustainable structure is provided that is powered by a rechargeable battery that is charged by alternating wind and solar energy generators.

### CROSS-REFERENCE TO RELATED APPLICATIONS

This application claims the benefit of U.S. provisional patent application Ser. No. 61/314,716 (filed Mar. 17, 2010) that is entitled “Sustainable modular structure powered by green energy.” This priority document is incorporated by reference as if fully set forth herein.

### STATEMENT REGARDING FEDERALLY SPONSORED RESEARCH OR DEVELOPMENT

Not Applicable.

### BACKGROUND OF THE INVENTION

1. Field of Invention

The invention relates to a modular structure or trailer that is constructed from recycled or environmentally friendly materials and that is further powered by utilizing alternative energy resources, such as energy generated by wind and/or solar power.

2. Background

Trailer or mobile structures are currently utilized quite extensively on construction sites or other temporary work environments, for educational purposes, and in connection with emergency response or disaster recovery organization. Generally, such mobile trailers are utilized by both the private and public sector to provide a working environment at remote locations for a small number of people on a temporary or sometimes permanent basis.

Although capable of providing a temporary on site work environment for remote laborers, most current trailers utilize a large amount of energy and have a negative net impact on the environment. Such excessive energy use and negative impact on the environment results from the portable trailers consumption of Alternate-Current (AC) electricity from the public power grid since: (1) most electricity in the public power grid is produced from the combustion of fossil fuels and, therefore, use thereof correspondingly pollutes the environment; and, (2) most electricity is initially produced as Direct-Current (DC) so that the use thereof requires a inversion of the electricity to AC, which inversion is inefficient. In some instances a gas-powered generator may be used to provide electricity to a mobile structure as an alternative to energy from the public electricity grid, but fuel is expensive, inefficiently converted to electricity (i.e., excessive energy consumption), and results in a negative environmental impact due to polluting emissions. A need therefore exists for a mobile workplace structure that both consumes less energy and results in a less negative environmental impact than most mobile work-place structures.

In addition to excessive energy consumption and negative environmental impacts, most mobile trailers and related workplace units are not entirely adequate for their intended purposes due to the expense and downtime involved in the setup and/or takedown thereof. The excessive down-time and expense may result from the need to connect the mobile structure to the public power grid since such a connection frequently involves negotiations with the power company, installation of public grid wiring to remote locations, obtaining permits, and the hiring of electricians and other professional specialists for connecting/disconnecting the mobile unit to the public grid wiring. In the case of mobile units with gas-powered generators, fuel for the generator is quickly consumed and can be expensive, particularly if the mobile unit is stationed at a remote work place or used for extended periods of time. Given these inadequacies, a need further exists for a mobile workplace structure that reduces costs and setup/takedown times in view of most existing mobile trailers and work-place units.

Finally, the U.S. Federal Government offers tax credits, known as LEED credits, for the use of more environmentally friendly structures at construction or other remote job sites. However, most mobile trailers do not qualify for the LEED credits given the above mentioned inadequacies. Accordingly, a need exists for a mobile workplace structure that produces tax benefits.

In summary, a need exists for a more environmentally friendly mobile structure, such as a trailer, for use in both the public and private sectors as a way to not only lower overall costs, reduce setup times, and produce tax benefits, but also to reduce any negative environmental impact resulting from ordinary mobile structures.

### SUMMARY OF THE INVENTION

In view of the foregoing, it is an object of this application to disclose an environmentally friendly mobile structure for providing a workplace that, in view of ordinary mobile structures, reduces overall costs, reduces setup/takedown times, produces tax benefits, and reduces negative environmental impacts resulting from the use thereof. As a preferable means for meeting the above-recited objective, this application discloses, among other things, an environmentally friendly mobile structure comprising: a chassis; at least one wheel that is temporarily or permanently attached to said chassis; a trailer hitch that is temporarily or permanently attached to said chassis; at least one side-wall disposed on said chassis; at least one end-wall disposed on said chassis; at least one roof over said side-wall(s) and end-wall(s); a solar powered electricity generator (e.g., an array of solar panels) positioned upon said roof; a wind powered electricity generator that may be removable to improve mobility of the structure; a DC battery bank that is electrically coupled to both of said solar and wind electricity generators for capturing unconsumed electricity; a DC to AC electricity inverter that is coupled to both of said solar and wind electricity generators; at least one DC electricity outlet coupled to said both of said solar panel array and said wind electricity generator so that appliances of the structure (e.g., lighting for the structure, exhaust and air circulation fans within the structure, refrigerators, and etcetera) may be powered with DC electricity produced by said solar panel array or said wind electricity generator; and, at least one AC outlet coupled to said DC to AC electricity inverter. Instead of a battery bank, the structure may feature an input to the public electricity grid. Instead of a DC to AC inverter, the structure may feature an AC outlet from the public electricity grid. Suitably, said structure should be adapted to accommodate at least one human workplace activity and may, therefore, include a conference room, a class room, an office, a kitchen, an equipment room, a lavoratory, or any room suitable for a work place or of a known designation or type. Preferably, the recited mobile unit consumes less energy than ordinary mobile units since its appliances may be run using DC rather than AC. The recited mobile structure has less of a negative impact on the environment since, among other reasons, consumed energy is suitably from solar or wind sources rather than from fossil fuel combustion. The recited mobile structure reduces costs and setup/takedown downtime because, among other reasons, the structure features a preinstalled solar powered generator that is coupled to the electrical circuit of the structure and the structure is adapted for easy attachment and coupling of the wind energy generator thereto. Finally, the mobile structure may qualify its user for the LEED tax credits since, in addition to other things, the mobile structure consumes energy from renewable sources.

### BRIEF DESCRIPTION OF THE FIGURES

The manner in which these objectives and other desirable characteristics can be obtained is better explained in the following description and attached figures in which:

FIG. 1A is a front perspective view of one example of a sustainable structure of the present invention.

FIG. 1B is a front side view of the structure illustrated in FIG. 1A.

FIG. 1C is a back side view of the structure illustrated in FIG. 1A.

FIG. 1D is a left side view of the structure illustrated in FIG. 1A.

FIG. 1E is a right side view of the structure illustrated in FIG. 1A.

FIG. 1F is a top view of the structure illustrated in FIG. 1A.

FIG. 2A is an example of one floor plan that may be utilized in the structure illustrated in FIG. 1A.

FIG. 2B is an example of a ceiling layout for the structure having a floor plan similar to that of FIG. 2A.

FIG. 2C is an example of an electrical plan for the structure having a floor plan similar to that of FIG. 2A.

FIG. 2D is an example of a mechanical plan for the structure having a floor plan similar to that of FIG. 2A.

FIG. 3A is a cross-section of the trailer of structure of FIGS. 1A & 2A illustrating the front interior of the structure.

FIG. 3B is a cross-section of the trailer of structure of FIGS. 1A & 2A illustrating the rear interior of the structure.

FIG. 3C is a cross-section of the trailer of structure of FIGS. 1A & 2A illustrating the right side interior of the structure.

FIG. 3D is a cross-section of the trailer of structure of FIGS. 1A & 2A illustrating the left side interior of the structure.

FIG. 4A is a representative cross-section of the left side wall of the structure of FIGS. 1A through 3D.

FIG. 4B is a representative cross-section of the right side wall of the structure of FIG. 1A through 3D.

FIG. 4C is an enlarged view of section A of the cross-section of FIG. 4A.

FIG. 4D is an enlarged view of section B of the cross-section of FIG. 3B and a cross section B of FIG. 4A.

FIG. 4E is an enlarged view of cross section C of the cross-section of FIGS. 4A and 4B.

FIG. 4F is an enlarged view of section D of the cross-section of FIG. 4A.

FIG. 5A is representative of a cross-section view taken along one side of a structure through a window in the structure of FIGS. 1A through 4H.

FIG. 5B is an enlarged view of section G of the cross-section of FIG. 5A.

FIG. 5C is an enlarged view of section H of the cross-section of FIG. 5A.

FIG. 6A plan view of the framing for the structure of FIGS. 1A through 5C.

FIG. 6B is a plan view of the framing for the right side wall of the structure of FIGS. 1A through 6A, including the installation of an electricity wind generator.

FIGS. 7A and 7B are schematic diagrams of a rechargeable battery bank that is charged by alternating wind and solar energy generators.

It is to be noted, however, that the appended figures illustrate only typical embodiments disclosed in this application, and therefore, are not to be considered limiting of its scope, for the invention may admit to other equally effective embodiments that will be appreciated by those reasonably skilled in the relevant arts. The components in the figures are not necessarily to scale, with an emphasis instead being placed upon illustrating the principles of the invention. In the figures, like reference numerals designate corresponding parts throughout the different views.

### DETAILED DESCRIPTION OF PREFFERED EMBODIMENTS

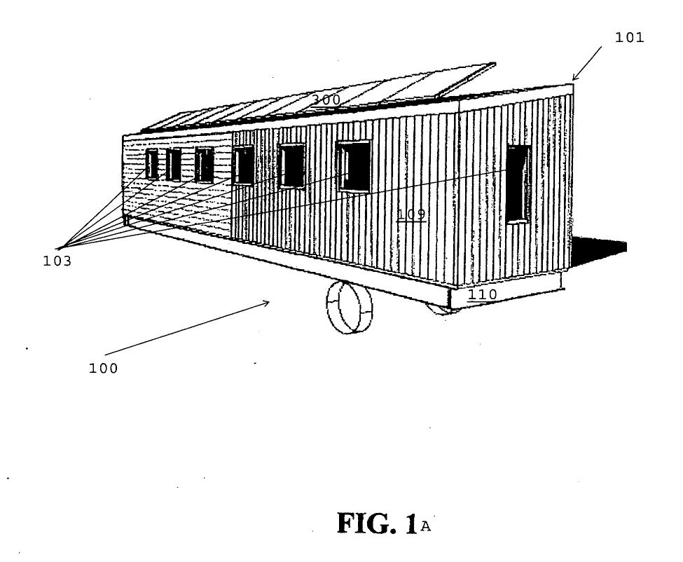

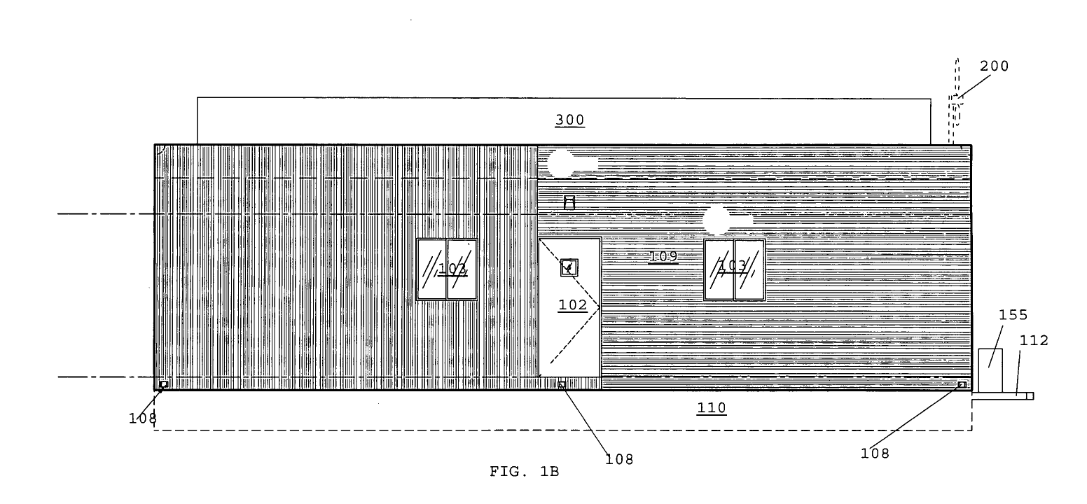

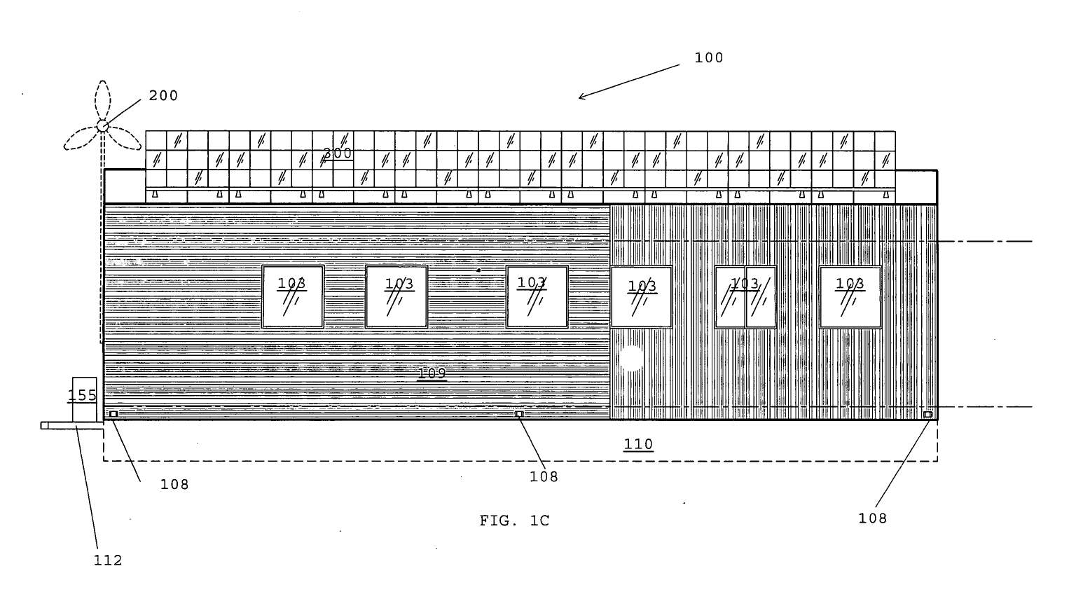

As illustrated in the attached FIGS. 1A through 7B, one example of a sustainable structure is provided that may be utilized for multiple purposes, such as construction offices, teaching facilities, emergency response facilities and other public and private sector needs for temporary, environmentally friendly, green powered structures.

FIG. 1A is a back-perspective view of one example of a sustainable structure 100 of the present patent application. FIGS. 1B, 1C, 1D, 1E and 1F are respectively front, back, left-side, right-side, and top views of the structure 100 of FIG. 1A. As illustrated in FIGS. 1A through 1F, the structure 100 may be a wood-framed modular structure 101 that is positioned atop a trailer chassis 110 with at least one wheel 111 and a trailer hitch 112. Still referring to the same figures, the modular structure 101 may be of the trailer or single-wide manufactured-home variety and should preferably include at least one entryway 102, at least one window 103 (one of which may be an emergency egress window (see, e.g., the window 103 on the left side (FIG. 1D)) of the structure 100), transportation lighting (including clearance lights 104 (see FIGS. 1D and 1E), identification lights 105 (see FIG. 1D), tail lights 106 (see FIG. 1D), turn signals 107 (see FIG. 1D), and marker lamps 108 (see FIGS. 1B and 1C). For improved ornamental appearance and weathering, siding 109 may be provided to the external structure of the modular unit 101. Finally, as discussed in greater detail below, the modular unit 101 may be powered by alternate energy, such as electricity generated by a wind-powered electricity generator 200 and/or a solar powered electricity generator 300 (e.g., an array of photovoltaic (PV) cells) that are externally attached to the modular unit 101.

The external dimensions of a modular structure 100 prepared according to this disclosure may vary, but nevertheless should remain suitable for a particular travel accommodation. For example, the dimensions of the structure 100 of FIGS. 1A through 1F are adapted for trailer travel (e.g., forty feet (40′) in length; eight feet six inches (8′6″) in width; fourteen feet (14′) in height (high end); and nine feet 6 and fifteen sixteenths inches (9′ 6 15/16″) in height (low end)). Although the figures depict the 100 as a trailer, the dimensions may be adapted to other travel accommodations, e.g., a structure prepared according to this disclosure may take the form of a railcar or a shipping container, among other things.

The construction of a modular unit atop a trailer chassis is a known art. Subject thereto, the disclosed structure 100 may include any number of the following features and materials in order to reduce the environmental impact of its construction:
Reclaimed interior wood cladding, net zero energy product
Recycled exterior metal cladding
Blown in soy expandable insulation
FSC Certified wood framing
750 kwh solar panel system
Ancillary wind generating system
Outback battery charging system
Soy based composition tile flooring
Composting toilet
Low-voltage interior circulation fans
Passive solar lighting and heating and cooling
Low-voltage high efficiency lighting
Natural gas/propane generator
   Installation of the wind-powered electricity generator 200 or the solar panel array 300 may be in advance of, or after, delivery of the structure 100 to a remote location or jobsite.

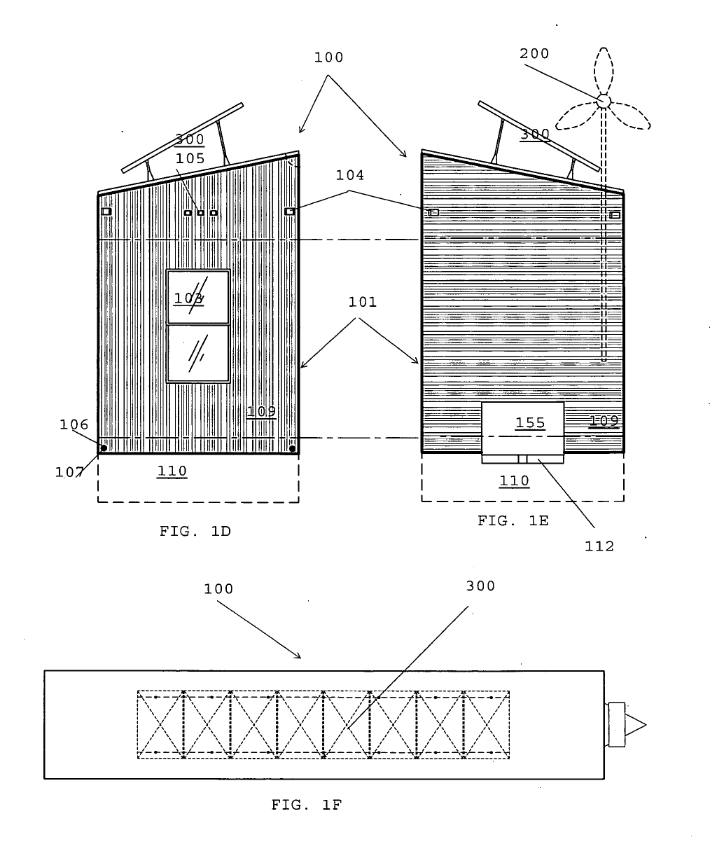

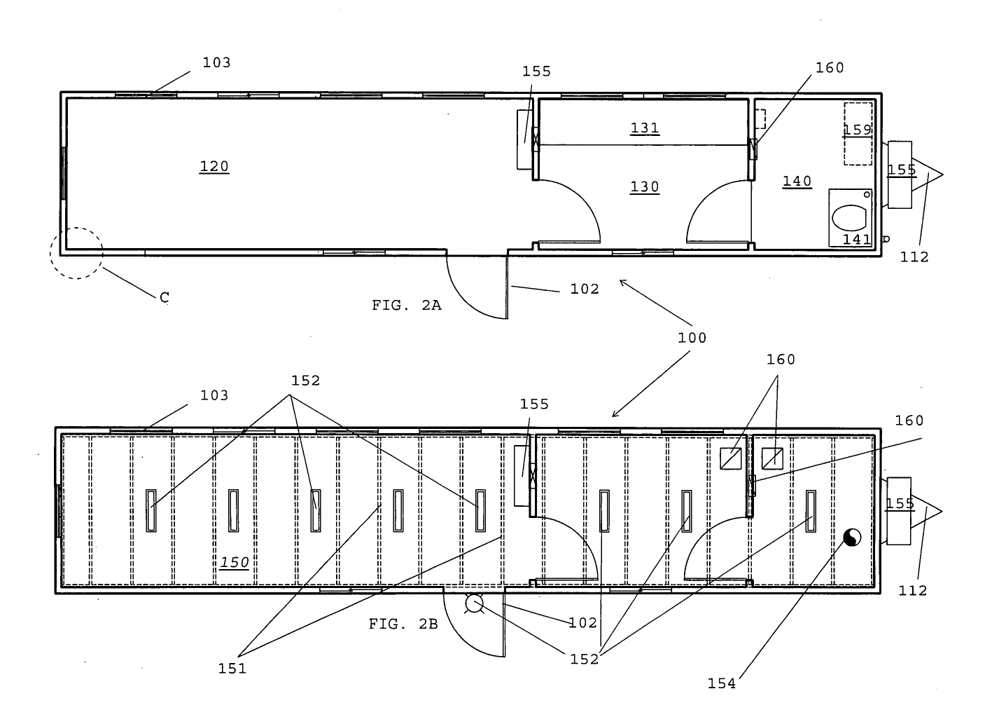

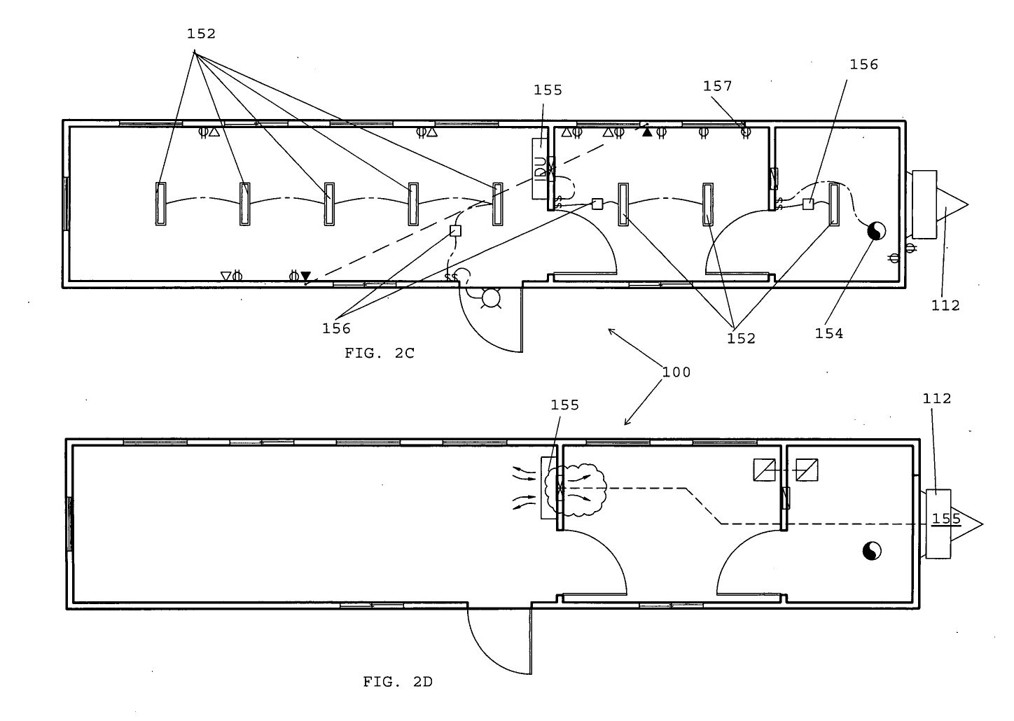

An example of the construction of the modular unit 101 of FIGS. 1A through 1F design is illustrated in FIGS. 2A through 7B. Those of skill in the art will know well how to read and interpret these figures.

FIG. 2A is an example of one floor plan that may be utilized in the structure 100. Referring to the figure, the exterior and interior walls may be constructed of 2×4 wood studs. As alluded to above, a purpose of the structure 100 is to provide a working environment for a small number of people on a temporary or sometimes permanent basis. Accordingly, the floor plan of FIG. 2A may feature a conference room 120, an office 130, and a lavoratory or equipment room 140. Optionally, the office may feature a built in desk 131 and the lavoratory 140 may feature a composting toilet 141 (vented through the roof). The particular flooring, wall paneling, and other finishes provided to the interior of the structure will depend on the location and activities conducted within and around the structure 100 and will be readily ascertainable by those of skill in the art.

FIG. 2B illustrates an example of a ceiling layout for the structure having a floor plan similar to that of FIG. 2A. As depicted in the figure, the internal ceiling 150 may be supported by 2x4 framing studs 151 that span the structure every twenty-four inches (24″) off-center. Also depicted in the figures, the ceiling 150 may feature at least one lighting fixture 152, at least one return air grille 153 or other ventilation means, and, optionally, an exhaust fan 154 for the lavoratory 140, and a heating/air-conditioning unit 155. As discussed in greater detail below, the appliances of the structure 100, including lighting fixtures 152, exhaust fans 154, and heating/air-conditioning units 155 should preferably operate on DC. Those of skill in the art will know well or readily ascertain the appropriate manner of finishing the ceiling of the structure 100.

FIG. 2C illustrates an example of an electrical plan for the structure having a floor plan and ceiling plan similar to that of FIGS. 2A and 2B respectively. As illustrated by the figures, the lighting fixtures 152, heating/air-conditioning units 155, and exhaust fans 154, are preferably connected via an electrical circuit. The circuit may include junction boxes 156, wiring 158, battery bank 159 (for unused electricity), and electrical sockets 157, that are coupled to the electricity generators (e.g., the solar 300 and/or wind-powered electricity generators). As alluded to above, the electricity produced by the electricity generators are suitably DC and, therefore, the appliances of the structure 100 should also preferably be DC so that no energy is lost by the inversion of DC to AC. This said, it may be necessary for AC to be available. Accordingly, the structure features a DC to AC inverter 160 that may be coupled to the electricity generators and the electrical circuit of the structure 100. Additionally, an AC socket that is coupled to the inverter 160 may be provided within the structure. Those skilled in the art will know well the type of wiring and circuitry necessary to couple the appliances of the structure 100 and the battery bank 159 to the electricity generators 200/300. A schematic of the electrical plan for the genertors is provided in FIGS. 7A and 7B. FIG. 2D is a mechanical plan for the heating/AC unit and ventilation.

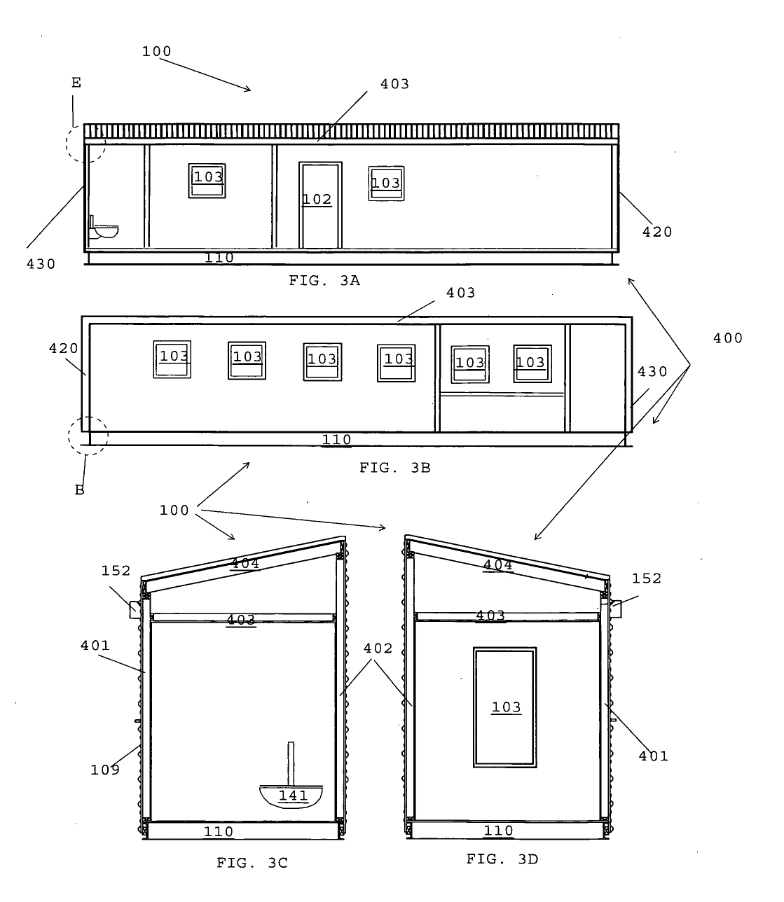

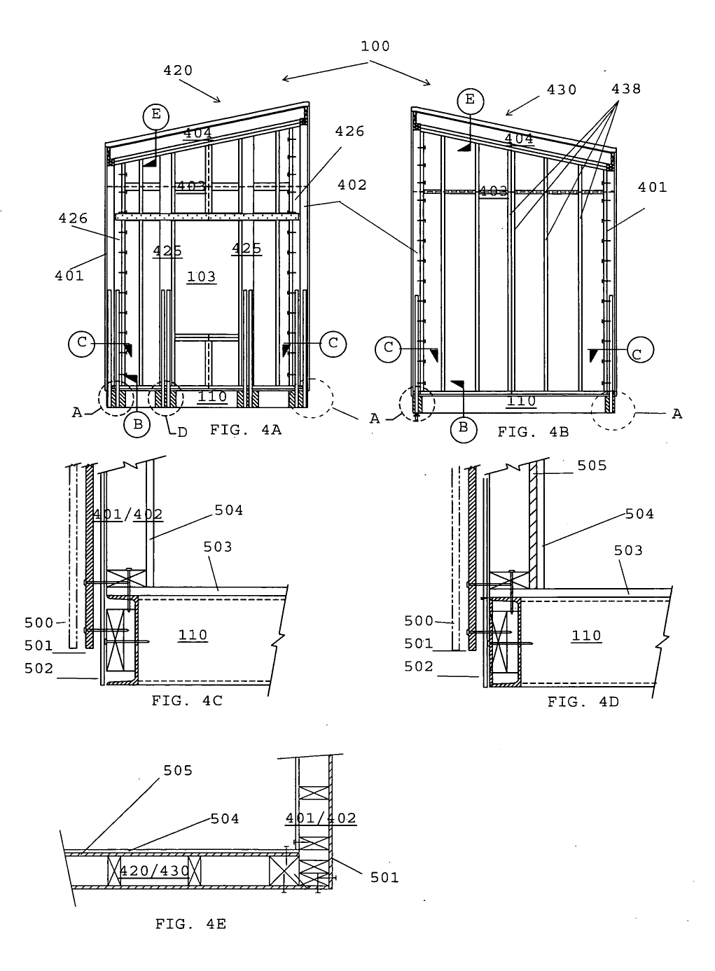

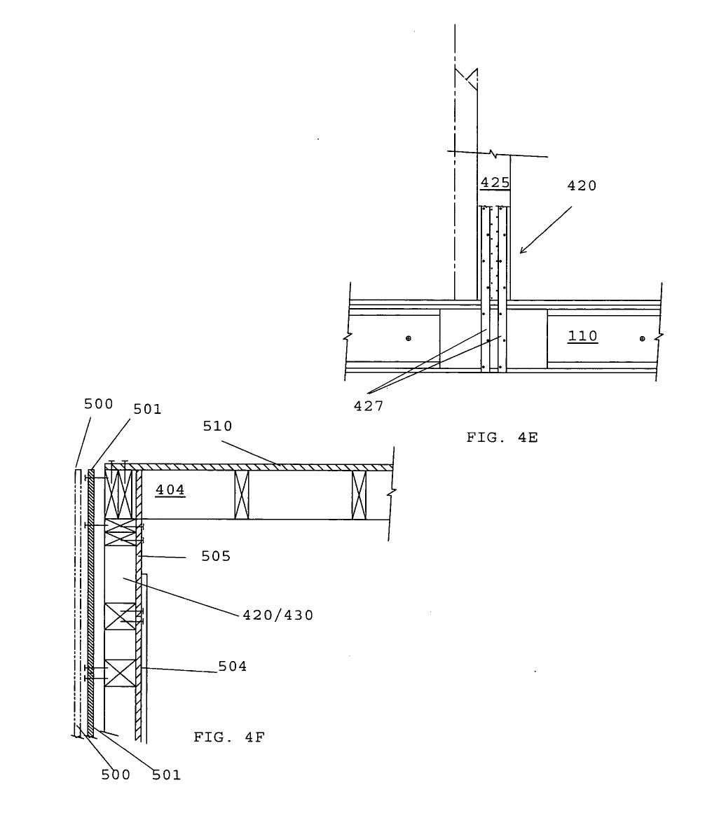

FIGS. 3A, 3B, 3C, and 3D are cross-sections of the trailer of structure of FIG. 1A illustrating respectively the front, back, right side and left side interior of the structure 100. As can be seen in these figures, the frame 400 of the structure 100 may preferably be comprised of: 2×4 studs along the front frame 401, back frame 402, and ceiling frame 403; and 2×6 studs along the roofing frame 404. The left 420 and right 430 side frames are best depicted in FIGS. 4A and 4B respectively. The framing 400 may suitably be positioned atop the chassis 110 and its floor joists. Those of skill in the art will readily appreciate the manner by which the frame 400 may be jointed, externally finished (e.g., siding over shear paneling, and exterior sheathing), and internally finished (e.g., sheet rock, wall paneling, and flooring) after reviewing this disclosure and accompanying figures.

FIGS. 4A and 4B are representative of cross-section views taken respectively across the left 420 and right 430 end wall frames of the structure 100 (see FIGS. 3A and 3B). FIG. 4A illustrates the framing of the left side wall 420, which may generally be comprised of two 2×6 studs 425 on either side of the window 103, and 4×4 blocking studs 426 that form joints with the front 401 and back 402 frames, 4×4 blocking/header 427 above and below the window 103. FIG. 4B illustrates the framing of the right side wall, which may generally be comprised of 2×4 studs 438. Those of skill in the art will know well the construction of such framing, including jointings and finishings.

FIG. 4C is an enlarged view of section A of FIGS. 4A and 4B. The figure generally depicts the jointing of either the front 401 or back 402 framing to the chassis 110 and its floor joists. Also depicted in the figure are the external and internal finishings, including the siding over shear panel 500, the external sheathing 501, a typical strap 502, the floor sheathing 503, and the internal wall finishings 504.

FIG. 4D is an enlarged view of section B of FIGS. 3A and 3B and a cross section B of FIGS. 4A and 4B. The figure generally depicts the jointing of either the left 420 or right 430 side wall frames to the chassis 110 and its floor joists. Also depicted in the figure are the external and internal finishings, including the siding over shear panel 500, the external sheathing 501, a typical strap 502, the floor sheathing 503, the internal wall finishings 504, and structural shear panels 505.

FIG. 4E is an enlarged view of section C of FIG. 2A and cross section C of the FIGS. 4A and 4B. The figure generally depicts the jointing of either the left 420 or right 430 side wall frames to either the front 401 or back 402 frames. Also depicted in the figure are the external and internal finishings, including the external sheathing 501, the internal wall finishings 504, and structural shear panels 505.

FIG. 4F is an enlarged view of section D of FIG. 4A. The figure depicts a typical holddown of the end wall frame 420 at the 2×6 studs 425. As depicted in the figure, the holddown is defined by at least one MST60 strap 426 that coupled to the 2×6 stud 425 and the chassis 110.

FIG. 4G is an enlarged view of section E of FIGS. 3C and 3D or the cross section E of FIGS. 4A and 4B. The figure generally depicts the jointing of either the left 420 or right 430 side wall frames to the roof frame 404. Also depicted in the figure is the external and internal finishings, including the siding over shear panel 500, the external sheathing 501, a roof sheathing 510, the internal wall finishings 504, and structural shear panels 505.

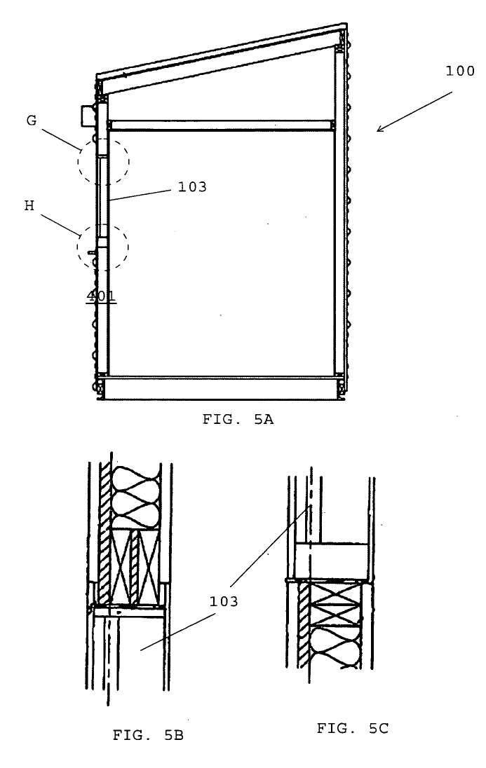

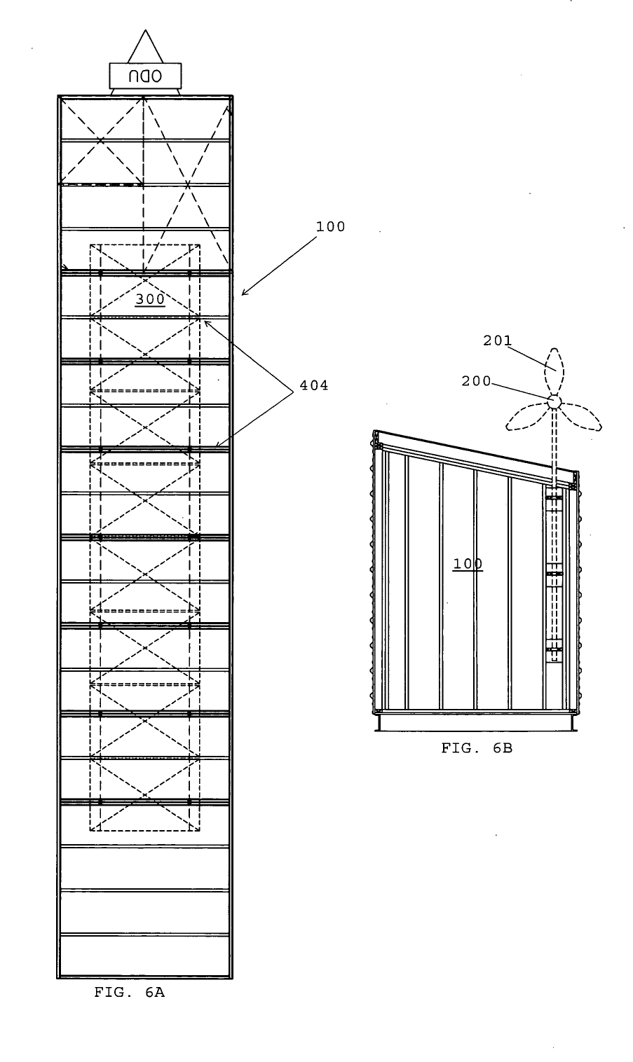

5A is cross section taken through a window in the structure 100. FIG. 5B is an enlarged view of section G of the cross-section of FIG. 5A. FIG. 5C is an enlarged view of section H of the cross-section of FIG. 5A.

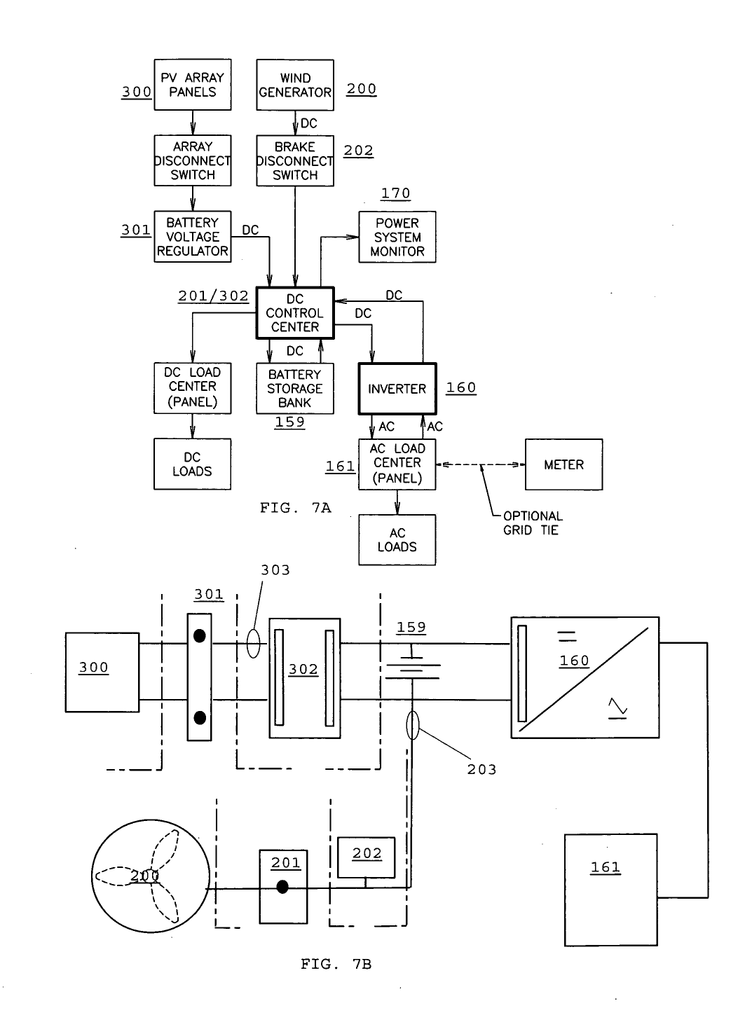

FIG. 6A depicts a top view of the roof frame 404. The roof frame 404 suitably supports the solar panel array 300 of the structure and, accordingly, the rafters of the roof frame 404 should be doubled as depicted to increase the load bearing capacity of the roof frame 404. Those of skill in the art will know well the manner of fastening and installing the solar panel array 300 to the structure 100.

FIG. 6B depicts the installation of the wind powered electricity generator 200. As can be seen in the figure, the wind turbine 201 of the generator 200 may be set atop a pipe that has been clamped, via pipe clamps, to the side of the structure 100. Wiring to and from the generator 200 may be disposed within the pipe. Those of skill in the art will know well the manner of fastening and installing the wind powered electricity generator 200 to the structure 100.

FIGS. 7A and 7B are schematic diagrams of a rechargeable battery bank: that is charged by the wind powered electricity generator 200 and solar panel array 300 (i.e., solar energy generators). The energy supply allows the structure 100 to be an off-grid hybrid solar and wind powered system.

The circuit of FIGS. 7A and 7B shows a photovoltaic (PV) array of 8 solar panels 300 producing 216 watts each to produce up to 1728 watts of total power from the PV array 300. The output is preferably DC with a total voltage of 57.42 V. This total voltage and wattage is produced by combining the 8 solar panels 300, via a solar combiner box 301, into one DC output that may be sent to the charge controller 302. A 60 amp fuse may be provided between the combiner box and charge controller to assure that only 60 amps of current is provided to the charge controller 302. The current may be carried along a one inch conduit. The charge controller 302 (also known as a charge regulator or battery regulator) limits the rate at which the electric current is added to or drawn from the battery pack. The charge controller 302 prevents overcharging and may prevent against overvoltage, which can reduce battery performance or lifespan, and may pose a safety risk. The charge controller 302 may also prevent complete drainage of the battery pack, or perform controlled electric discharges, depending on the battery technology, to protect battery life. Generally, the charge controller may be a transformer capable of stepping down the 57.42 VDC from the PV array to 24 VDC for feeding the battery pack to charge them.

A wind activated electric generator 200 is also shown that is capable of producing 400 watts of DC with a voltage of 24 V. The wind activated electric generator 200 outputs a current to a junction box 201 transition that may allow the use of one inch conduit to pass the current to the battery bank through a 60 amp fuse 203. The junction box 201 is a device, module, and/or component capable of protecting the system from both surges and voltage drops that could potentially route back through the system and damage the batteries or inverter. The junction box may also include a plug (not shown) to plug the system to a power grid or supply power from the system to the power grid.

The wind activated electric generator 200 may be controlled by a turbine stop switch 202 that is coupled to an output signal path from the wind activated electric generator 200 to the battery bank 159. The turbine stop switch 202 turns on and off the wind activated electric generator 200 when necessary to properly charge the battery pack 159. The turbine stop switch 202 may be triggered by a feed from a battery capacity indicator box. When the battery capacity indicator falls below a defined setting, it triggers the turbine stop switch 202, which releases a brake on the wind activated electric generator 200. The battery bank 159 may include 6-12 VDC batteries wired to produce a total of 24 VDC and capable of storing and producing 258 amps of DC. The battery bank 159 may be connected to a DC and AC back panel capable of operating up to 3500 watts of power. The back panel may include a power inverter capable of producing 120 volts of single phase AC at 60 hertz with a continuous AC output of 29.2 amps. The AC output may then be passed, via a 15 amp fuse, to a 15 amp circuit breaker panel 161 to distribute AC power throughout the structure.

It is recognized by those skilled in the art that the construction and design of the structure may be modified from that illustrated in the attached figures. The example provided in the figures is for illustration purposes only. The trailer in the illustration is a 44′×10′ construction trailer, but may be designed to be other sizes. For a trailer of this size, the roof area required for the panels will be approximately 150 Square Feet. The roof is further designed to accommodate 8-216 Watt Panels and constructed to support approximately 500 lbs of additional load.

In operation, the trailer must be positioned such that the solar panels are south facing. An adjustable Solar PV racking system is installed on the roof and will allow the panels to be adjusted for moving the trailer. The wind generator will be mounted to the trailer using a pole mounted system. The inverter system will be configured for a single phase 120 Volt system using step up transformer. The system may also include a minimum 5 KW generator and may be used to charge the batteries. A grid-tied option for the batteries may be substituted for the generator.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

These aspects, among other things, demonstrate the industrial applicability of this invention.

Moreover, it should be apparent that further numerous structural modifications and adaptations may be resorted to without departing from the scope and fair meaning of the present invention as set forth hereinabove and as described herein below by the claims.

I claim:

1. A mobile structure that is adapted to receive at least one human, said structure comprising:
a solar powered electricity generator;
a wind powered electricity generator; and,
at least one DC electricity outlet coupled to at least one of said wind or solar powered electricity generators.

2. The mobile structure of claim 1 further comprising a trailer chassis jointed to said structure.

3. The mobile structure of claim 2 further comprising at least one wheel and a trailer hitch.

4. The mobile structure of claim 1 wherein the solar powered electricity generator is an array of photovoltaic solar panels.

5. The mobile structure of claim 1 wherein the solar wind powered electricity generator comprises a wind turbine.

6. The mobile structure of claim 1 further comprising a DC battery bank that is electrically coupled to at least one of said wind or solar powered electricity generators so that unconsumed electricity may be collected.

7. The mobile structure of claim 1 further comprising a public power grid coupled to at least one of said wind or solar powered electricity generators so that unconsumed electricity may be provided to said public power grid.

8. The mobile structure of claim 1 further comprising:
a DC to AC electricity inverter that is coupled to at least one of said wind or solar powered electricity generators; and,
an AC outlet coupled to said inverter.

9. The mobile structure of claim 1 further wherein said adaptation to receive a human is a room within the structure selected from the group consisting essentially of a conference room, a class room, an office, a kitchen, an equipment room, and a lavoratory.

10. The mobile structure of claim 1 wherein the structure is a trailer.

11. The mobile structure of claim 1 wherein the structure is a railcar.

12. The mobile structure of claim 1 wherein the structure is a shipping container.

13. The mobile structure of claim 1 further comprising a composting toilet.

14. A method of producing electricity comprising the steps
delivering a mobile structure to a remote location, said structure being adapted to receive at least one human;
providing a solar powered electricity generator to said structure;
providing a wind powered electricity generator to said structure, and,
coupling at least one DC electricity outlet to at least one of said wind or solar powered electricity generators.

15. The method of claim 14 wherein the solar powered electricity generator is an array of photovoltaic solar panels.

16. The method of claim 14 wherein the solar wind powered electricity generator comprises a wind turbine.

17. The method of claim 14 further comprising the step of coupling a DC battery bank to at least one of said wind or solar powered electricity generators so that unconsumed electricity may be collected.

18. The method of claim 14 further comprising the step of coupling a public power grid to at least one of said wind or solar powered electricity generators so that unconsumed electricity may be provided to said public power grid.

19. The method of claim 14 further comprising the steps of:
coupling a DC to AC electricity inverter to at least one of said wind or solar powered electricity generators; and,
coupling an AC outlet to said inverter.

20. A mobile structure comprising:
at least one side-wall;
at least one roof jointed with said side-wall(s) so that the structure formed by said joint is adapted to receive at least one human;
a solar powered electricity generator on said roof;
a wind powered electricity generator that is removably and externally attached to at least one of said side-wall(s), end-wall(s), or roof, wherein the wind powered electricity generator may be removed from the structure to improve the mobility of the structure; and,
at least one DC electricity outlet coupled to at least one of said wind or solar powered electricity generators.
